(19) United States
(12) Patent Application Publication
(10) Pub. No.: US 2026/0241930 A1
(43) Pub. Date: Aug. 20, 2026

(54) VEHICLE CONTROL DEVICE AND CONTROL METHOD

(71) Applicant: TOYOTA JIDOSHA KABUSHIKI KAISHA, Aichi (JP)

(72) Inventor: Takahiro MAEDA, Toyota-shi (JP)

(21) Appl. No.: 19/533,301

(22) Filed: Feb. 9, 2026

(30) Foreign Application Priority Data
Feb. 18, 2025 (JP) 2025-024175

(51) Int. Cl. B60W 30/095; B60W 30/18; B60W 50/14

(52) U.S. Cl. CPC B60W 30/0956; B60W 30/18109; B60W 50/14; B60W 2540/225; B60W 2554/4041

(57) ABSTRACT

The present disclosure provides a control device that suppresses unnecessary activation of vehicle control. The control device performs vehicle control for reducing collision damage between a host vehicle and a target object, including warning control for issuing a warning. The device determines whether the target object is a visually recognized target recognized by the occupant, and executes the warning control when an execution condition indicating a collision possibility equal to or greater than a predetermined level is satisfied. For a target object determined to be visually recognized, the device sets a specific state in which the execution condition is less likely to be satisfied, and maintains the specific state even after the target object is no longer determined to be visually recognized, as long as a change amount in a relative positional relationship between the host vehicle and the target object remains within a predetermined range.

### CROSS-REFERENCE TO RELATED APPLICATION

This application claims priority to Japanese Patent Application No. JP 2025-024175 filed on Feb. 18, 2025, the content of which is hereby incorporated by reference in its entirety into this application.

### BACKGROUND OF THE INVENTION

### 1. Field of the Invention

The present disclosure relates to a vehicle control device and a control method.

### 2. Description of the Related Art

For example, Japanese Patent Application Laid-Open (kokai) No. 2021-026720 discloses a technique in which surrounding information of a vehicle is acquired, a risk area is predicted using the acquired surrounding information, and vehicle control is switched based on a degree of deviation between the predicted risk area and the driver's line-of-sight position.

In the technique described in Patent Document 1, even when a driver has recognized a risk area, if the driver's line-of-sight position subsequently deviates from the risk area by a predetermined amount or more, an intervention to switch vehicle control is carried out. Accordingly, even if the driver has recognized the risk area, vehicle control may be unnecessarily activated, which can cause annoyance to the driver.

### SUMMARY OF THE INVENTION

The present disclosure has been made in order to solve the above-described problem, and aims to effectively suppress unnecessary activation of vehicle control.

A device according to at least one embodiment of the present disclosure is a vehicle control device configured to execute one or both of warning control for issuing a warning to an occupant of a host vehicle and deceleration control for decelerating the host vehicle, as vehicle control for reducing collision damage between the host vehicle and a target object present around the host vehicle, the vehicle control device comprising:
a determination unit configured to determine whether the target object is a visually recognized target recognized by the occupant; and
a control unit configured to execute one or both of the warning control and the deceleration control when an execution condition is satisfied in which a possibility of a collision between the host vehicle and the target object becomes equal to or greater than a predetermined level,
wherein the control unit is configured to:
set, for the target object determined by the determination unit to be the visually recognized target, a specific state in which the execution condition is less likely to be satisfied; and
maintain the specific state even when the target object is no longer determined to be the visually recognized target by the determination unit, as long as a change amount in a relative positional relationship between the host vehicle and the target object is equal to or less than a predetermined amount.

### BRIEF DESCRIPTION OF THE DRAWINGS

FIG. 1 is a schematic diagram illustrating a hardware configuration of a vehicle according to the present embodiment.

FIG. 2 is a schematic diagram illustrating a software configuration of a control device according to the present embodiment.

FIG. 3A is a schematic diagram illustrating an example of a scene in which vehicle control is unnecessarily activated.

FIG. 3B is a schematic diagram illustrating another example of a scene in which vehicle control is unnecessarily activated.

FIG. 4A is a schematic diagram illustrating a passenger compartment of the host vehicle.

FIG. 4B is a schematic bird's-eye view illustrating surroundings of the host vehicle.

FIG. 5 is a schematic diagram illustrating an example of a data table used when a subtraction time is set as a variable value.

FIG. 6 is a schematic diagram illustrating an example of a data table used when a threshold variation amount is set as a variable value.

FIG. 7 is a schematic diagram illustrating an example of a scene in which a threshold time changing process according to the present embodiment is executed.

FIG. 8 is a schematic diagram illustrating another example of a scene in which the threshold time changing process according to the present embodiment is executed.

FIG. 9 is a schematic diagram illustrating yet another example of a scene in which the threshold time changing process according to the present embodiment is executed.

FIG. 10 is a flowchart illustrating a routine of the threshold time changing process according to the present embodiment.

### DESCRIPTION OF THE EMBODIMENTS

Hereinafter, a vehicle control device and a control method according to the present embodiment will be described with reference to the drawings.

### Hardware Configuration

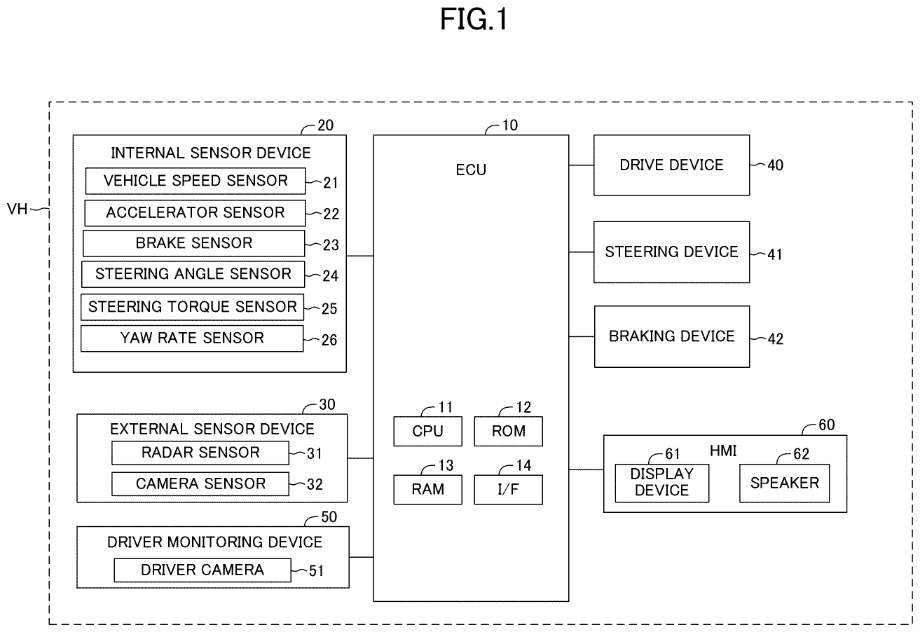

FIG. 1 is a schematic diagram illustrating a hardware configuration of a vehicle VH according to the present embodiment. In the following description, the vehicle VH may also be referred to as a host vehicle when distinguishing it from other vehicles.

The vehicle VH includes an ECU (Electronic Control Unit) 10. The ECU 10 includes a CPU (Central Processing Unit) 11, a ROM (Read Only Memory) 12, a RAM (Random Access Memory) 13, and an interface device 14. The CPU 11 is a processor that executes various programs stored in the ROM 12. The ROM 12 is a non-volatile memory that stores data necessary for the CPU 11 to execute various programs. The RAM 13 is a volatile memory that provides a work area in which various programs are developed when executed by the CPU 11. The interface device 14 is a communication device for communicating with external devices.

The ECU 10 serves as a central device that performs driving support such as pre-crash safety control (PCS control) and following-vehicle approach warning control. Driving support includes the concept of autonomous driving. The ECU 10 is communicably connected to an internal sensor device 20, an external sensor device 30, a drive device 40, a steering device 41, a braking device 42, a driver monitoring device 50, and an HMI (Human Machine Interface) 60.

The internal sensor device 20 includes sensors that acquire the state of the vehicle VH. The internal sensor device 20 includes a vehicle speed sensor 21, an accelerator sensor 22, a brake sensor 23, a steering angle sensor 24, a steering torque sensor 25, a yaw rate sensor 26, and others.

The vehicle speed sensor 21 detects a traveling speed (vehicle speed V) of the vehicle VH. The accelerator sensor 22 detects an operation amount of an accelerator pedal (not shown) operated by the driver. The brake sensor 23 detects an operation amount of a brake pedal (not shown) operated by the driver. The steering angle sensor 24 detects a rotational angle (steering angle) of a steering wheel or steering shaft (not shown). The steering torque sensor 25 detects a rotational torque (steering torque) of the steering wheel or steering shaft (not shown). The yaw rate sensor 26 detects the yaw rate of the vehicle VH. The internal sensor device 20 transmits the state of the vehicle VH detected by sensors 21 to 26 to the ECU 10 at predetermined intervals.

The external sensor device 30 includes sensors that acquire target information relating to objects (hereinafter “surrounding targets”) present around the vehicle VH. The external sensor device 30 includes a radar sensor 31 and a camera sensor 32. Surrounding targets include, for example, other vehicles, pedestrians, fallen objects, road signs, and the like.

The radar sensor 31 may include a millimeter-wave radar and/or a LiDAR. The millimeter-wave radar emits radio waves in the millimeter-wave band and receives millimeter waves reflected by a target present within the emission range. Based on the phase difference between the transmitted and received millimeter waves, attenuation level of the reflected waves, and the time from transmission to reception, it acquires relative distance, relative speed, and the like between the vehicle VH and surrounding targets. The LiDAR sequentially scans in multiple directions with pulsed laser light having a shorter wavelength than millimeter waves, and receives reflected light from targets. Thus, it acquires relative distance, relative speed, target shape, and other information.

The camera sensor 32 captures images of the surroundings of the vehicle VH and processes the captured image data to acquire target information of surrounding targets. The camera sensor 32 may be a digital camera having an image sensor such as a CMOS or CCD. Target information includes information indicating types of surrounding targets, their relative distance from the vehicle VH, relative speed, and so forth. Target type recognition may be performed, for example, using machine learning such as pattern matching.

The external sensor device 30 repeatedly transmits the acquired target information to the ECU 10 at predetermined time intervals. Note that the external sensor device 30 does not necessarily include both the radar sensor 31 and the camera sensor 32; it may include only one of them.

The drive device 40 generates driving force transmitted to drive wheels of the vehicle VH. Examples of the drive device 40 include an electric motor and an engine. The steering device 41 applies steering force to wheels of the vehicle VH. The braking device 42 applies braking force to wheels of the vehicle VH.

The driver monitoring device 50 acquires the state of the driver of the vehicle VH, and includes, for example, a driver camera 51. The driver camera 51 mainly captures the driver's face and detects driver face orientation, gaze direction, and the like from the captured facial image. The driver monitoring device 50 transmits driver state information (hereinafter “driver monitoring information”) acquired based on detection results of the driver camera 51 to the ECU 10 at predetermined intervals.

The HMI 60 is an interface for inputting and outputting information between the ECU 10 and occupants (mainly the driver) of the host vehicle VH, and includes an input device and an output device. Examples of input devices include a touch panel, switches, and a voice input microphone. Examples of output devices include a display device 61 and a speaker 62. The display device 61 may be, for example, a center display, a multi-information display, or a head-up display. The speaker 62 may be a speaker of an audio system or navigation system.

### Software Configuration

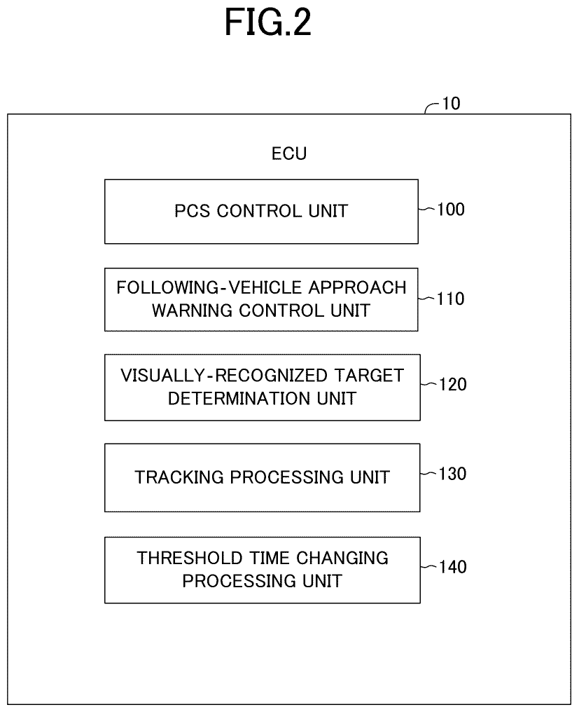

FIG. 2 is a schematic diagram illustrating a software configuration of the control device according to the present embodiment.

As shown in FIG. 2, the ECU 10 includes, as functional elements, a PCS control unit 100, a following-vehicle approach warning control unit 110, a visually-recognized target determination unit 120, a tracking processing unit 130, a threshold time changing processing unit 140, and the like. These functional elements 100 to 140 are implemented when the CPU 11 of the ECU 10 reads out programs stored in the ROM 12 into the RAM 13 and executes them. Note that all or part of the functional elements 100 to 140 may alternatively be provided in another ECU separate from the ECU 10, or in an information processing apparatus of a facility (such as a management center) that is capable of communicating with the vehicle VH.

The PCS control unit 100 executes PCS control for reducing damage caused by a collision between the host vehicle VH and a target object present in the traveling direction of the host vehicle VH. The PCS control unit 100 determines whether the target object is an obstacle that may collide with the host vehicle VH. The PCS control unit 100 acquires coordinate information of the target object based on target information transmitted from the external sensor device 30. The PCS control unit 100 also calculates a turning radius of the host vehicle VH based on detection results of the vehicle speed sensor 21, the steering angle sensor 24, and the yaw rate sensor 26, and calculates a trajectory of the host vehicle VH based on the turning radius. When the target object is a moving object, the PCS control unit 100 calculates a trajectory of the moving object based on coordinate information of the moving object, and determines the target object as an obstacle when the trajectory of the moving object intersects the trajectory of the host vehicle VH. When the target object is a stationary object, the PCS control unit 100 determines the target object as an obstacle when the trajectory of the host vehicle VH intersects a current position of the stationary object.

When the PCS control unit 100 determines that the target object is an obstacle, it calculates a collision prediction time (Time To Collision, TTC), which is a predicted time until the host vehicle VH collides with the obstacle, based on a distance D from the host vehicle VH to the obstacle and a relative speed Vr between the host vehicle VH and the obstacle. The TTC is an index value indicating the possibility that the host vehicle VH will collide with the obstacle. The PCS control unit 100 calculates the TTC by dividing the distance D from the host vehicle VH to the obstacle, acquired based on detection results of the external sensor device 30, by the relative speed Vr (TTC=D/Vr).

The PCS control unit 100 executes, as PCS controls, PCS warning control, pre-crash brake assist (PBA) control, light pre-crash brake (LPB) control, and autonomous emergency brake (AEB) control, and the like. The PCS warning control is control for alerting the driver, via the HMI 60, to the risk of a collision with an obstacle. The PBA control is assist control that assists braking operation when the driver depresses a brake pedal. The LPB control is braking control that applies a relatively small braking force to the host vehicle VH at a stage prior to the AEB control even if the driver does not depress the brake pedal. The AEB control is braking control that forcibly applies a relatively large braking force to the host vehicle VH. Details of these PCS controls will be described below.

When the PCS control unit 100 has determined the target object as an obstacle and the TTC becomes equal to or less than a predetermined first threshold time TV1, the PCS control unit 100 executes the PCS warning control to prompt an alert to the driver. The PCS warning control is executed, for example, by displaying an alert image on the display device 61 or outputting a warning sound from the speaker 62.

After executing the PCS warning control, when the TTC becomes equal to or less than a predetermined second threshold time TV2, which is smaller than the first threshold time TV1, and the driver depresses the brake pedal by at least a predetermined amount, the PCS control unit 100 executes the PBA control. The PBA control is executed by setting an assist hydraulic pressure of, for example, a master cylinder (not shown) of the braking device 42 higher than in a normal state, thereby improving a response characteristic with respect to the driver's brake pedal depression. The assist hydraulic pressure may be set as a constant value, or may be set to increase stepwise as the TTC decreases.

After executing the PCS warning control, when the TTC becomes equal to or less than a predetermined third threshold time TV3, which is smaller than the first threshold time TV1, the PCS control unit 100 executes the LPB control to decelerate the vehicle VH even if the driver does not depress the brake pedal. The LPB control is executed by operating the braking device 42 to apply a relatively small braking force to the vehicle VH. The third threshold time TV3 may be a value larger than the second threshold time TV2 as long as it is smaller than the first threshold time TV1, or may be a value equal to or less than the second threshold time TV2.

After executing the LPB control or the PBA control, when the TTC becomes equal to or less than a predetermined fourth threshold time TV4, which is smaller than the second threshold time TV2 and the third threshold time TV3, the PCS control unit 100 executes the AEB control to rapidly decelerate the vehicle VH even if the driver does not depress the brake pedal. The AEB control is executed by operating the braking device 42 to apply a relatively large braking force to the vehicle VH.

The following-vehicle approach warning control unit 110 executes a following-vehicle approach warning control that alerts an occupant (mainly the driver) when a following vehicle present in a rear region of the host vehicle VH approaches the host vehicle VH. In the present disclosure, the rear region of the host vehicle VH may include not only a region directly behind the host vehicle VH but also regions laterally behind the host vehicle VH. The following-vehicle approach warning control unit 110 determines whether a following vehicle is an approaching vehicle that is approaching the host vehicle VH. The following-vehicle approach warning control unit 110 acquires a vehicle speed of the following vehicle based on target information transmitted from the external sensor device 30. When the vehicle speed of the following vehicle is higher than the vehicle speed V of the host vehicle VH acquired by the vehicle speed sensor 21, the following-vehicle approach warning control unit 110 determines the following vehicle as an approaching vehicle.

When the following-vehicle approach warning control unit 110 determines the following vehicle as an approaching vehicle, it calculates the TTC (=D/Vr) by dividing a distance D from the host vehicle VH to the approaching vehicle by a relative speed Vr based on detection results of the external sensor device 30. When the TTC becomes equal to or less than a predetermined fifth threshold time TV5, the following-vehicle approach warning control unit 110 executes the following-vehicle approach warning control to alert the driver that the following vehicle is approaching. The following-vehicle approach warning control is executed, for example, by displaying an alert image on the display device 61 or outputting a warning sound from the speaker 62.

For convenience, in the following description, the first to fifth threshold times TV1 to TV5 are collectively referred to as “threshold time TV.” Also, when it is unnecessary to distinguish between the PCS control and the following-vehicle approach warning control, they are collectively referred to as “vehicle control.”

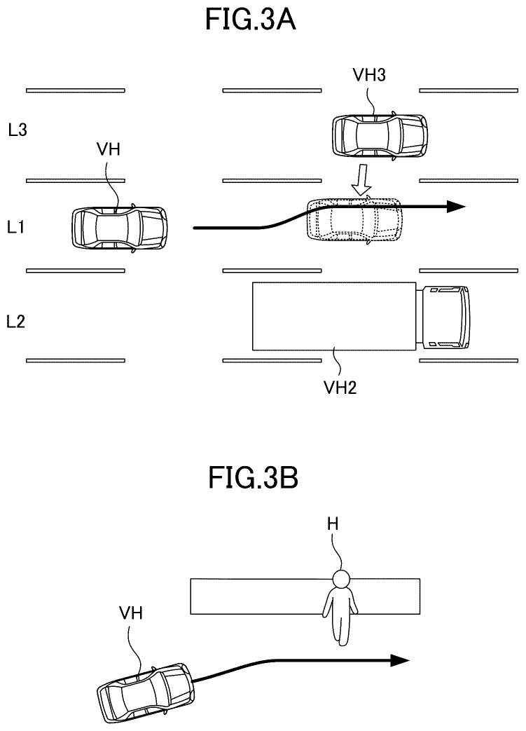

Incidentally, when vehicle control is performed based on the threshold time TV with respect to a target that the driver of the host vehicle VH has visually recognized (hereinafter “visually-recognized target”), the vehicle control may be unnecessarily activated, thereby causing annoyance to the driver. One example of such unnecessary activation is a scene as illustrated in FIG. 3A. In FIG. 3A, reference sign L1 denotes a host lane in which the host vehicle VH is traveling, reference sign L2 denotes a right adjacent lane adjacent to the right side of the host lane L1, and reference sign L3 denotes a left adjacent lane adjacent to the left side of the host lane L1. Reference sign VH2 denotes a large vehicle traveling in the right adjacent lane L2 ahead of the host vehicle VH, and reference sign VH3 denotes a passenger car traveling in the left adjacent lane L3 ahead of the host vehicle VH.

In the scene shown in FIG. 3A, it is assumed that the driver of the host vehicle VH visually recognizes both the large vehicle VH2 ahead and the passenger car VH3. In this case, it is conceivable that the driver of the host vehicle VH intentionally moves the host vehicle VH closer to the passenger car VH3 in order to secure a lateral distance (road-width direction) from the large vehicle VH2. In such a situation, for example, if the PCS warning control as vehicle control is activated, there is a problem in that the driver may feel annoyed.

Another example of unnecessary activation of vehicle control is, for example, a scene as illustrated in FIG. 3B. In FIG. 3B, reference sign H denotes a guide person at a parking lot, gasoline station, charging station, or the like. In the scene shown in FIG. 3B, it is assumed that the driver of the host vehicle VH visually recognizes the guide person H and intentionally brings the host vehicle VH closer to the guide person H in accordance with instructions from the guide person H. In such a situation, if the PCS control (for example, AEB control) as vehicle control is activated, there is a problem in that the driver may feel annoyed.

In order to suppress such unnecessary activation of vehicle control, it is conceivable that, for visually-recognized targets that the driver of the host vehicle VH is viewing, the threshold time TV is reduced so that the execution conditions for vehicle control are less likely to be satisfied. However, for example, in the scene illustrated in FIG. 3A, suppose that after the driver of the host vehicle VH visually recognizes the passenger car VH3, the passenger car VH3 moves to a position indicated by the broken line, that is, the relative positional relationship greatly changes. In such a case, if the state in which the threshold time TV has been reduced is maintained, the risk of a collision between the host vehicle VH and the passenger car VH3 may increase, thereby possibly reducing safety. In other words, it is desirable to achieve both suppression of unnecessary activation of vehicle control and ensuring of safety. Hereinafter, details of each functional element for achieving both suppression of unnecessary activation of vehicle control and ensuring of safety will be described.

The visually-recognized target determination unit 120 determines whether a surrounding target present around the host vehicle VH is a visually-recognized target that has been visually recognized by the driver of the host vehicle VH. Specifically, the visually-recognized target determination unit 120 acquires the driver's line-of-sight direction based on driver monitoring information transmitted from the driver monitoring device 50. The visually-recognized target determination unit 120 determines a surrounding target present in the acquired driver's line-of-sight direction as a visually-recognized target recognized by the driver.

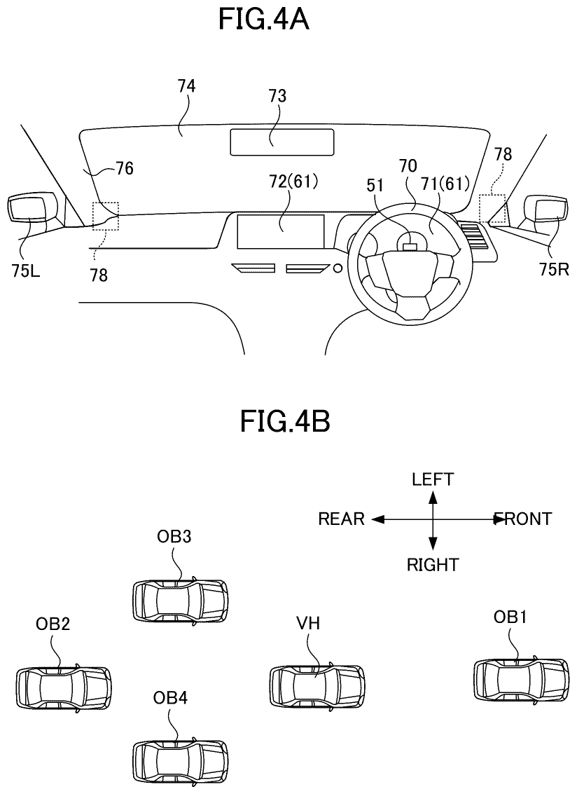

FIG. 4A is a schematic diagram illustrating a passenger compartment of the host vehicle VH. In FIG. 4A, reference sign 70 denotes a steering wheel, reference sign 71 denotes a meter display including a multi-information display, reference sign 72 denotes a center display, reference sign 73 denotes a rearview mirror, reference sign 74 denotes a windshield, reference signs 75L and 75R denote a left side mirror and a right side mirror, respectively, and reference sign 76 denotes an A-pillar. FIG. 4B is a schematic bird's-eye view of surroundings of the host vehicle VH as viewed from above. In FIG. 4B, reference signs OB1 to OB4 denote surrounding targets such as other vehicles present around the host vehicle VH.

For example, when the driver's line-of-sight direction acquired based on the driver monitoring information is directed toward the surrounding target OB1 in front through the windshield 74, the visually-recognized target determination unit 120 determines that the surrounding target OB1 present in a front region of the host vehicle VH is a visually-recognized target visually recognized by the driver. Also, when the driver's line-of-sight direction acquired based on the driver monitoring information is directed toward the rearview mirror 73, the visually-recognized target determination unit 120 determines that the surrounding target OB2 present in a rear region of the host vehicle VH is a visually-recognized target visually recognized by the driver.

Further, for example, when the driver's line-of-sight direction acquired based on the driver monitoring information is directed toward the left side mirror 75L, the visually-recognized target determination unit 120 determines that the surrounding target OB3 present in a left lateral region of the host vehicle VH is a visually-recognized target visually recognized by the driver. Similarly, when the driver's line-of-sight direction acquired based on the driver monitoring information is directed toward the right side mirror 75R, the visually-recognized target determination unit 120 determines that the surrounding target OB4 present in a right lateral region of the host vehicle VH is a visually-recognized target visually recognized by the driver. When the host vehicle VH is provided with electronic side mirrors, the visually-recognized target determination unit 120 may determine a surrounding target (OB3, OB4) present in the left lateral region or the right lateral region as a visually-recognized target when the driver's line-of-sight direction is directed toward a monitor 78 (see the broken line) provided near the A-pillar 76 inside the cabin.

When the visually-recognized target determination unit 120 determines that the surrounding targets OB1 to OB4 are visually-recognized targets, the tracking processing unit 130 acquires a relative positional relationship of each visually-recognized target with respect to the host vehicle VH based on detection results of the external sensor device 30. The relative positional relationship includes, for example, a direction of the visually-recognized target with respect to the host vehicle VH, a relative distance, and a relative speed. Hereinafter, a relative positional relationship of a visually-recognized target first acquired by the tracking processing unit 130 is referred to as an “initial relative positional relationship.” When the tracking processing unit 130 acquires the initial relative positional relationship of a visually-recognized target, it temporarily stores the acquired initial relative positional relationship in a storage unit (for example, the RAM 13) of the ECU 10 in association with the visually-recognized target. After storing the initial relative positional relationship, the tracking processing unit 130 successively acquires a change amount RP in the relative positional relationship from the initial relative positional relationship of the visually-recognized target based on detection results of the external sensor device 30. The tracking processing unit 130 transmits the acquired change amount RP of the relative positional relationship to the threshold time changing processing unit 140 in real time.

The threshold time changing processing unit 140 executes threshold time changing processing that reduces a threshold time TV for vehicle control with respect to a target determined as a visually-recognized target by the visually-recognized target determination unit 120 (hereinafter also referred to as a “target object”), thereby bringing the system into a state (a specific state in the present disclosure) in which the execution conditions for vehicle control are less likely to be satisfied. As a method of reducing the threshold time TV, for example, a predetermined subtraction time Ts may be subtracted from the threshold time TV. The subtraction time Ts may be a fixed value or may be a variable value.

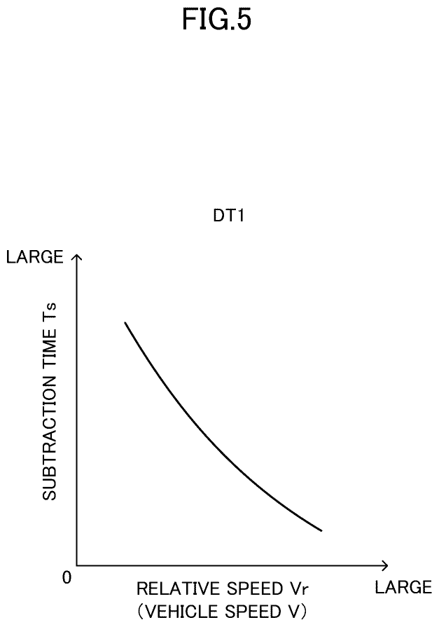

FIG. 5 shows an example of a data table DT1 used when the subtraction time Ts is a variable value. The data table DT1 is a table referred to based on a relative speed Vr between the host vehicle VH and the target object, and is stored in advance in a storage unit of the ECU 10. In the data table DT1, the subtraction time Ts is set so as to become smaller as the relative speed Vr increases. The threshold time changing processing unit 140 sets the subtraction time Ts by referring to the data table DT1 based on the relative speed Vr between the host vehicle VH and the target object, which is acquired from detection results of the external sensor device 30. That is, when the relative speed Vr between the host vehicle VH and the target object is high, the threshold time changing processing unit 140 subtracts a relatively small subtraction time Ts from the threshold time TV, thereby suppressing a decrease amount of the threshold time TV. Accordingly, when the relative speed Vr between the host vehicle VH and the target object is high, it is possible to effectively suppress a situation in which safety is extremely reduced. Note that the data table DT1 may alternatively be a table referred to based on a vehicle speed V of the host vehicle VH. In this case as well, the subtraction time Ts may be set smaller as the vehicle speed V of the host vehicle VH increases.

After reducing the threshold time TV for vehicle control with respect to the target object, the threshold time changing processing unit 140 maintains the reduced threshold time TV as long as the driver's line-of-sight direction is directed toward the target object (that is, as long as the visually-recognized target determination unit 120 determines the target object as a visually-recognized target). Accordingly, when the driver intentionally attempts to bring the host vehicle VH closer to the target object, it is possible to effectively suppress unnecessary activation of vehicle control.

Further, after reducing the threshold time TV for vehicle control with respect to the target object, even when the driver's line-of-sight direction is directed from the target object to another direction, the threshold time changing processing unit 140 maintains the reduced threshold time TV as long as a change amount RP in the relative positional relationship of the target object is equal to or less than a predetermined threshold change amount RPv. That is, even when the visually-recognized target determination unit 120 no longer determines the target object as a visually-recognized target, the state in which the execution conditions for vehicle control are less likely to be satisfied is maintained for the target object once visually recognized by the driver, as long as the relative positional relationship does not greatly change. Accordingly, it is possible to effectively suppress unnecessary activation of vehicle control with respect to a target object once visually recognized by the driver.

On the other hand, after reducing the threshold time TV for vehicle control with respect to the target object, when the driver's line-of-sight direction is directed to a direction other than the target object and the change amount RP of the relative positional relationship of the target object exceeds the threshold change amount RPv, the threshold time changing processing unit 140 returns the criterion for determining whether the execution conditions for vehicle control are satisfied back to the threshold time TV. Accordingly, even for a target object once visually recognized by the driver, it is possible to effectively suppress an increase in collision risk with respect to a target object whose relative positional relationship has greatly changed. In other words, it is possible to effectively ensure safety. The threshold change amount RPv may be a fixed value or may be a variable value.

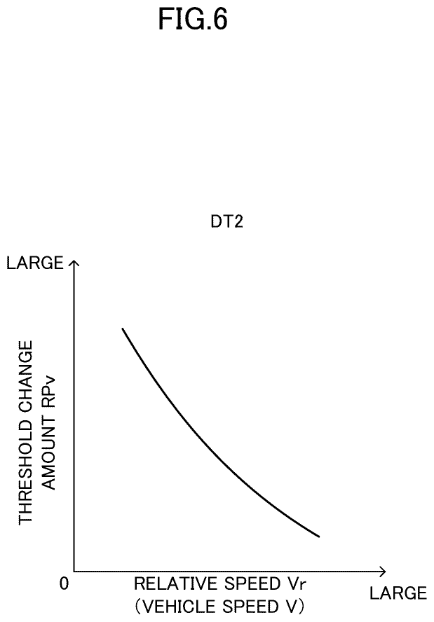

FIG. 6 shows an example of a data table DT2 used when the threshold change amount RPv is a variable value. The data table DT2 is a table referred to based on the relative speed Vr between the host vehicle VH and the target object, and is stored in advance in a storage unit of the ECU 10. In the data table DT2, the threshold change amount RPv is set so as to become smaller as the relative speed Vr increases. The threshold time changing processing unit 140 sets the threshold change amount RPv by referring to the data table DT2 based on the relative speed Vr between the host vehicle VH and the target object, which is acquired from detection results of the external sensor device 30. That is, when the relative speed Vr between the host vehicle VH and the target object is high, the threshold change amount RPv is set to a relatively small value. Accordingly, when the relative speed Vr between the host vehicle VH and the target object is high, even if the change amount RP in the relative positional relationship is relatively small, the criterion for determining whether the execution conditions for vehicle control are satisfied is more likely to return to the threshold time TV. Thus, it is possible to effectively suppress a situation in which safety is greatly impaired when the relative speed Vr between the host vehicle VH and the target object is high. Note that the data table DT2 may alternatively be a table referred to based on the vehicle speed V of the host vehicle VH. In this case as well, the threshold change amount RPv may be set smaller as the vehicle speed V of the host vehicle VH increases.

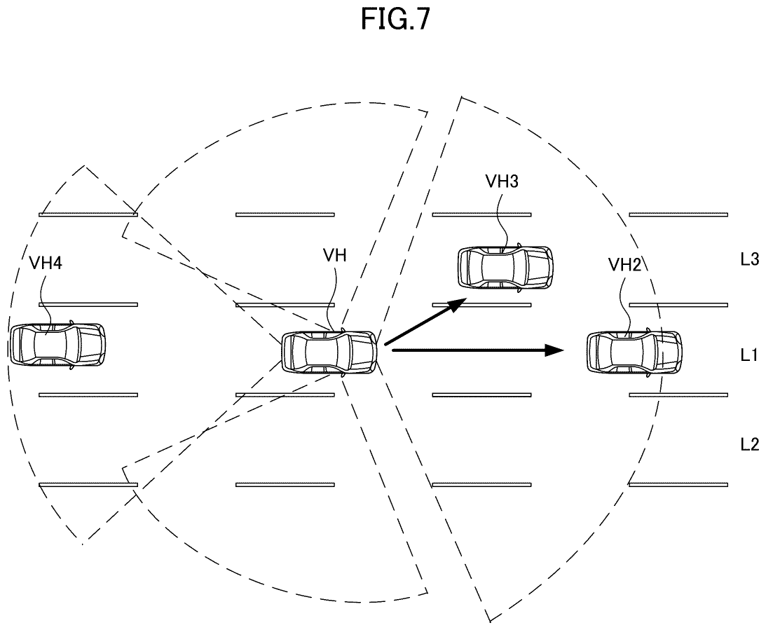

Next, specific examples of scenes in which the threshold time changing processing according to the present embodiment is executed will be described with reference to FIGS. 7 to 9. In FIGS. 7 to 9, regions surrounded by broken lines illustratively indicate detection ranges of the external sensor device 30.

FIG. 7 illustrates an example in which the driver of the host vehicle VH visually recognizes another vehicle VH2 in front of the host vehicle VH and another vehicle VH3 at a front lateral side of the host vehicle VH, but does not visually recognize another vehicle VH4 behind the host vehicle VH. In this case, since the other vehicles VH2 in front and VH3 at the front lateral side are visually-recognized targets, the threshold time changing processing unit 140 reduces the threshold time TV used as a criterion for determining whether the execution conditions for vehicle control (for example, PCS control) are satisfied, with respect to these vehicles. The state in which the threshold time TV has been reduced is maintained as long as the change amount RP in the relative positional relationship between the host vehicle VH and the other vehicles VH2, VH3 is equal to or less than the threshold change amount RPv. That is, unnecessary activation of vehicle control with respect to the other vehicle VH2 in front and the other vehicle VH3 at the front lateral side is suppressed. On the other hand, with respect to the other vehicle VH4 behind, the criterion for determining whether the execution conditions for vehicle control (for example, following-vehicle approach warning control) are satisfied is maintained at the threshold time TV. In other words, vehicle control with respect to the other vehicle VH4 is performed as normal.

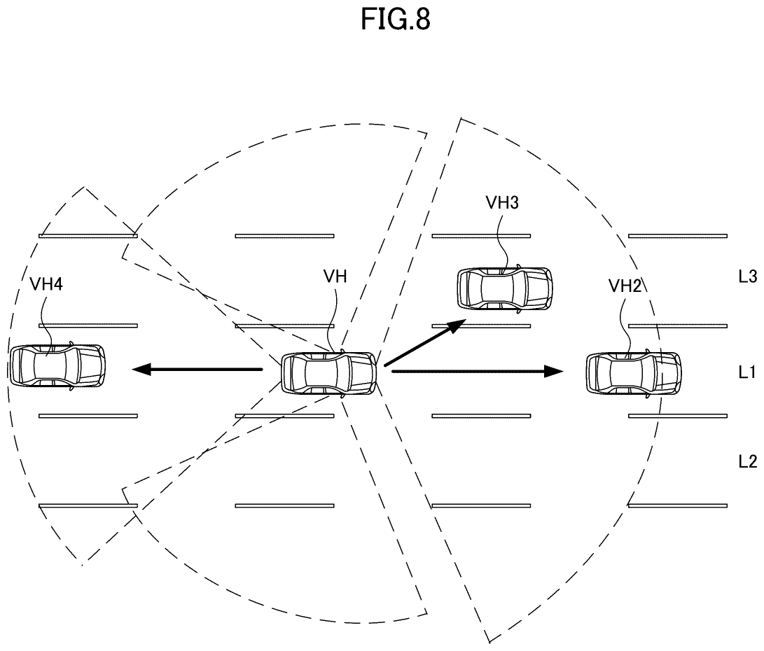

FIG. 8 illustrates an example in which the driver of the host vehicle VH visually recognizes all of the other vehicle VH2 in front of the host vehicle VH, the other vehicle VH3 at the front lateral side of the host vehicle VH, and the other vehicle VH4 behind the host vehicle VH. In this case, the threshold time changing processing unit 140 reduces the threshold time TV used as a criterion for determining whether the execution conditions for vehicle control are satisfied, with respect to the other vehicle VH2 in front, the other vehicle VH3 at the front lateral side, and the other vehicle VH4 behind. The state in which the threshold time TV has been reduced is maintained as long as the change amount RP in the relative positional relationships between the host vehicle VH and the other vehicles VH2, VH3, VH4 is equal to or less than the threshold change amount RPv. That is, unnecessary activation of vehicle control (for example, PCS control) with respect to the other vehicle VH2 in front and the other vehicle VH3 at the front lateral side, and vehicle control (for example, following-vehicle approach warning control) with respect to the other vehicle VH4 behind is suppressed.

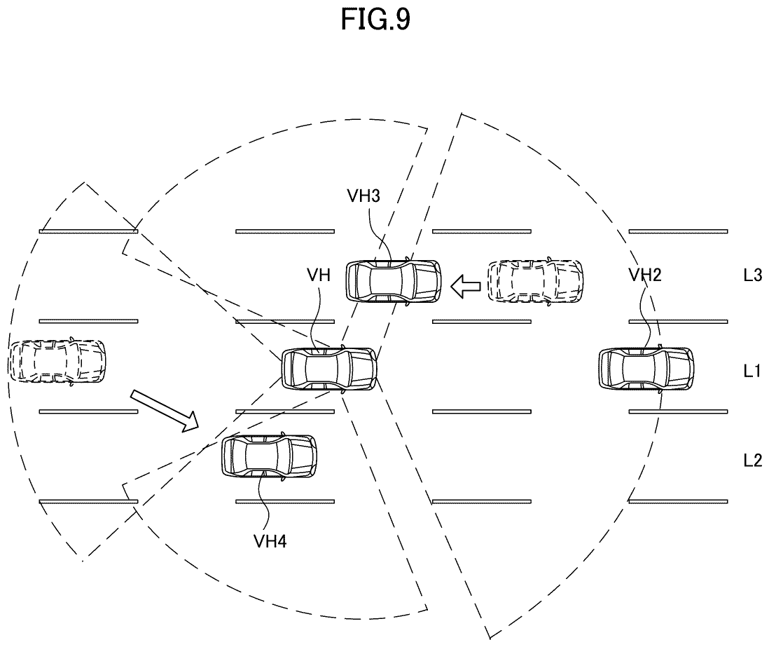

FIG. 9 illustrates an example in which, from the state shown in FIG. 8, the relative positional relationships of the other vehicle VH3 at the front lateral side of the host vehicle VH and the other vehicle VH4 behind the host vehicle VH greatly change. That is, FIG. 9 illustrates a case where the change amount RP in the relative positional relationships of the other vehicle VH3 at the front lateral side and the other vehicle VH4 behind, with respect to the host vehicle VH, exceeds the threshold change amount RPv. In this case, the threshold time changing processing unit 140 maintains the state in which the threshold time TV used as a criterion for determining whether the execution conditions for vehicle control (for example, PCS control) are satisfied is reduced with respect to the other vehicle VH2 in front. On the other hand, with respect to the other vehicle VH3 at the front lateral side and the other vehicle VH4 behind, the threshold time changing processing unit 140 returns the criterion for determining whether the execution conditions for vehicle control are satisfied back to the threshold time TV. Accordingly, when the collision risk between the host vehicle VH and the other vehicle VH3 at the front lateral side or the other vehicle VH4 behind increases, it is possible to effectively ensure safety.

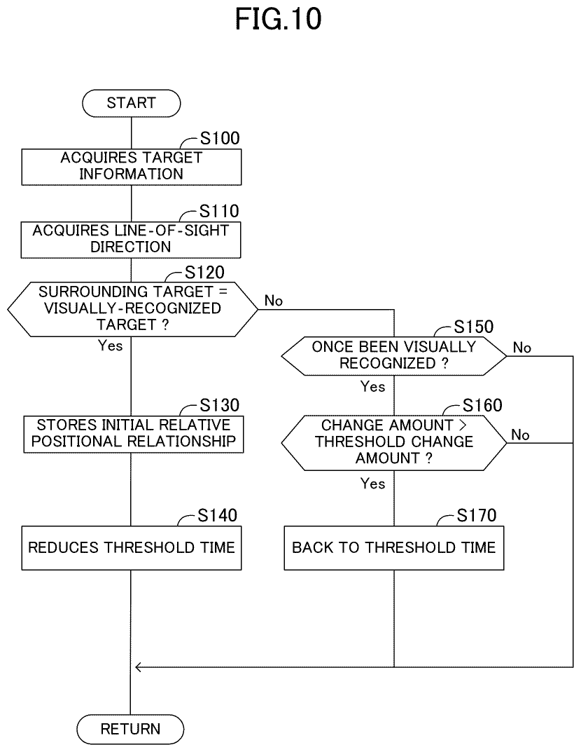

FIG. 10 is a flowchart illustrating a routine of the threshold time changing processing executed by the CPU 11 of the ECU 10. This routine is started, for example, when the host vehicle VH starts traveling.

In step S100, the ECU 10 acquires target information of surrounding targets present around the host vehicle VH based on detection results of the external sensor device 30. Next, in step S110, the ECU 10 acquires the driver's line-of-sight direction based on driver monitoring information transmitted from the driver monitoring device 50. Note that the processes of steps S100 and S110 may be performed in any order and may be performed simultaneously.

In step S120, the ECU 10 determines whether each surrounding target is a visually-recognized target visually recognized by the driver based on position information of the surrounding targets and the driver's line-of-sight direction. When a surrounding target is a visually-recognized target (Yes), the ECU 10 proceeds to the processing of step S130. On the other hand, when a surrounding target is not a visually-recognized target (No), the ECU 10 proceeds to the processing of step S150.

When the processing proceeds from step S120 to step S130, the ECU 10 acquires and stores a relative positional relationship detected by the external sensor device 30, that is, an initial relative positional relationship of the visually-recognized target with respect to the host vehicle VH, when the surrounding target is determined to be a visually-recognized target. Next, in step S140, the ECU 10 executes the threshold time changing processing that reduces the threshold time TV used as a criterion for determining whether the execution conditions for vehicle control with respect to the visually-recognized target are satisfied. Thereafter, the ECU 10 returns this routine.

When the processing proceeds from step S120 to step S150, the ECU 10 determines whether the surrounding target determined in step S120 as not being a visually-recognized target is a target object that has once been visually recognized by the driver. When the surrounding target is not a target object once visually recognized by the driver (No), the ECU 10 returns this routine. On the other hand, when the surrounding target is a target object once visually recognized by the driver (Yes), the ECU 10 proceeds to the processing of step S160.

In step S160, the ECU 10 determines whether the change amount RP of the relative positional relationship of the target object with respect to the host vehicle VH exceeds the threshold change amount RPv. When the change amount RP of the relative positional relationship does not exceed the threshold change amount RPv (No), the ECU 10 returns this routine. That is, when the threshold time TV has been reduced by the threshold time changing processing, that reduced value is maintained. On the other hand, when the change amount RP of the relative positional relationship exceeds the threshold change amount RPv (Yes), the ECU 10 proceeds to the processing of step S170, executes the threshold time changing processing that returns the criterion for determining whether the execution conditions for vehicle control are satisfied back to the threshold time TV, and then returns this routine.

While the vehicle control device and control method according to the present embodiment have been described above, the present disclosure is not limited to the above embodiment, and various modifications can be made without departing from the spirit and scope of the present disclosure. For example, in the above embodiment, the execution conditions for vehicle control (PCS control and following-vehicle approach warning control) have been described as being determined based on the TTC, but the configuration may instead be such that vehicle control is executed when a distance between the host vehicle VH and a surrounding target becomes equal to or less than a threshold distance. In this case, with respect to the target object, the threshold distance may be reduced so that the execution conditions for vehicle control are less likely to be satisfied (specific state). Furthermore, the technique of the present disclosure can also be applied to an autonomous driving vehicle that automatically performs a part or all of driving operations. In this case, it is sufficient that the control of the present disclosure is made to function when the driving operation is switched from autonomous driving to manual driving.

What is claimed is:

1. A vehicle control device configured to execute one or both of warning control for issuing a warning to an occupant of a host vehicle and deceleration control for decelerating the host vehicle, as vehicle control for reducing collision damage between the host vehicle and a target object present around the host vehicle, the vehicle control device comprising:
a determination unit configured to determine whether the target object is a visually recognized target recognized by the occupant; and
a control unit configured to execute one or both of the warning control and the deceleration control when an execution condition is satisfied in which a possibility of a collision between the host vehicle and the target object becomes equal to or greater than a predetermined level,
wherein the control unit is configured to:
set, for the target object determined by the determination unit to be the visually recognized target, a specific state in which the execution condition is less likely to be satisfied; and
maintain the specific state even when the target object is no longer determined to be the visually recognized target by the determination unit, as long as a change amount in a relative positional relationship between the host vehicle and the target object is equal to or less than a predetermined amount.

2. The vehicle control device according to claim 1,
wherein the control unit is configured to cancel the specific state when the target object is no longer determined to be the visually recognized target by the determination unit and the change amount exceeds the predetermined amount.

3. The vehicle control device according to claim 1, further comprising:
a line-of-sight direction acquisition unit configured to acquire a line-of-sight direction of the occupant,
wherein the determination unit is configured to determine whether the target object is the visually recognized target based on the line-of-sight direction acquired by the line-of-sight direction acquisition unit.

4. The vehicle control device according to claim 1,
wherein the control unit is configured to determine that the execution condition is satisfied when a distance between the host vehicle and the target object or a predicted time until a collision between the host vehicle and the target object becomes equal to or less than a predetermined threshold, and
wherein, in setting the specific state, the control unit is configured to reduce the threshold with respect to the target object.

5. A vehicle control method for executing one or both of warning control for issuing a warning to an occupant of a host vehicle and deceleration control for decelerating the host vehicle, as vehicle control for reducing collision damage between the host vehicle and a target object present around the host vehicle, the vehicle control method comprising:
determining whether the target object is a visually recognized target recognized by the occupant;
executing one or both of the warning control and the deceleration control when an execution condition is satisfied in which a possibility of a collision between the host vehicle and the target object becomes equal to or greater than a predetermined level; and
for the target object determined to be the visually recognized target, setting a specific state in which the execution condition is less likely to be satisfied and maintaining the specific state even when the target object is no longer determined to be the visually recognized target, as long as a change amount in a relative positional relationship between the host vehicle and the target object is equal to or less than a predetermined amount.
